(19) United States
(12) Patent Application Publication
(10) Pub. No.: US 2013/0116917 A1
(43) Pub. Date: May 9, 2013

(54) System having mobile telephones wirelessly networked via a shared central server

(71) Applicant: Robert Bosch GmbH, Stuttgart (DE)

(72) Inventor: Sebastian BOEHM, Bietigheim (DE)

(73) Assignee: Robert Bosch GmbH, Stuttgart (DE)

(21) Appl. No.: 13/671,074

(22) Filed: Nov. 7, 2012

(30) Foreign Application Priority Data
Nov. 7, 2011 (DE) 10 2011 085 814.8

(51) Int. Cl. G06F 17/00; G08G 1/00

(52) U.S. Cl. 701/118; 701/1

(57) ABSTRACT

The present method and system is intended to provide improved communication between multiple vehicles. This is achieved by a system which has mobile telephones networked in wireless manner via a shared central server, each mobile telephone being connected to a communication line of a vehicle which provides vehicle data, such that a user receives vehicle data and/or vehicle positions of the other users and displays that information on a display of the mobile telephone.

### RELATED APPLICATION INFORMATION

The present application claims priority to and the benefit of German patent application no. 10 2011 085 814.8, which was filed in Germany on Nov. 7, 2011, the disclosure of which is incorporated herein by reference.

### FIELD OF THE INVENTION

The present invention relates to a system having mobile telephones wirelessly networked via a shared central server.

### BACKGROUND INFORMATION

Travel groups split up among multiple vehicles often wish to obtain information about the respective other vehicles. The communication between the vehicles may take place via mobile telephones. For example, a traveler can read out a fill level of a tank and inform a fellow traveler in another vehicle of the result. However, this is not practical when many vehicles are involved.

U.S. Pat. No. US 6,292,747 B1 discusses a network having multiple GPS receiver that allows the exchange of information between multiple vehicles. The individual vehicles are interconnected in wireless manner via a shared router. However, in this system the vehicles must move in relatively close proximity.

Patent document WO 2009 084 785 A1 discusses a navigation system, which has a communication connection to a server and thereby allows an exchange of information.

In JP 09210699 A, a display unit is discussed, which displays a position of the own vehicle and the position of another vehicle. This design includes voice recognition.

In US 2007 007 8595 A1, a system based on short messages is introduced, which forwards positional information. This makes it possible to recover a stolen vehicle.

### SUMMARY OF THE INVENTION

The exemplary embodiments and/or exemplary methods of the present invention are based on the objective of finding a way for improved communication between multiple vehicles.

This objective may be achieved by a system as described herein.

With the aid of the exemplary embodiments and/or exemplary methods of the present invention, the driver or passenger is able to be connected to his or her “virtual” travel group. A selection of data available in the vehicle may be transmitted to a central server, for instance in anonymized form.

The exemplary embodiments and/or exemplary methods of the present invention are based on providing a smartphone application, which connects the driver or the passenger to a travel group split up among multiple vehicles. The smartphone application may have access to various internal vehicle data and forward a selection of such data to a web server. In addition to using these data for the application, the data, in anonymized form, are usable for further services on the server.

For example, the driver or passenger is able to obtain a display of a vehicle status of his “friends”, such as a position, a tank fill level or the like, on a general map of the smartphone application, for instance.

The system according to the exemplary embodiments and/or exemplary methods of the present invention offers an application that may be called “drive together” or “joint travel” and which constitutes a form of a “car-2-car” or vehicle-to-vehicle communication. Travel groups split up among several vehicles, for instance, may use their smartphones to view the position, speed and/or tank fill level of their travel mates, make arrangements for common rest periods or, for example, detect a vehicle breakdown. The data additionally required for this purpose are provided by the vehicle.

The connection of the vehicles may take place via smartphone. Using this mobile telephone program or the “drive together” application, the smartphones are able to establish a WLAN connection or some other connection to the vehicle. The vehicles or smartphones simultaneously connect to a provided server, via UMTS or some other connection. The server stores the vehicle data that was provided or forwarded by the smartphone.

If the driver dials his virtual travel companions in the application, the server checks, for example, whether the driver has the right to view the data of his travel companions. If that is the case, the server is able to transmit the corresponding data of the vehicle. An identification may be implemented via the so-called VIN or vehicle chassis number, for instance.

In addition, the server can transmit an anonymized key to the driver's smartphone.

It would additionally be possible to use the data available on the servers to improve or update existing navigation map material, for instance. For it may be assumed that the location in which a vehicle is traveling also must be a road.

This makes it possible to prepare forecasts of traffic congestion. The detection of broken down vehicles and traffic volume and the like are possible as well.

A WLAN node which gives the smartphone access to internal vehicle data may be situated inside the vehicle.

Advantageous further developments of the exemplary embodiments and/or exemplary methods of the present invention are indicated and described herein.

In one advantageous further development of the system according to the present invention, the central server is a web server. The connection of the mobile telephones via the Internet allows the vehicles to be located at any distance from each other.

One further development of the exemplary embodiments and/or exemplary methods of the present invention is distinguished by the fact that data are transmitted to the central server and/or from the central server to another service provider in encrypted form. This prevents unauthorized persons from gaining access to the data.

It is conceivable that each mobile telephone is connected, e.g., in wireless manner or by radio, to an additional navigation device, which is permanently installed or which is connected as mobile device; however, each mobile telephone may be equipped with a GPS receiver.

A further important measure is that the vehicle data and/or the vehicle positions are able to be displayed on a general map of the individual mobile telephone. The driver or passenger therefore is able to gain an overview of the vehicle positions very quickly.

Another, very decisive improvement with regard to the realization of the idea according to the present invention is that each mobile telephone is implemented as smartphone provided with an application for shared networking. Applications for mobile telephones are easy to program and market via an “APP store”.

In principle, a communication between vehicle and mobile telephone is possible via a cable connection. A communication from the mobile telephone to the vehicle expediently takes place by way of a wireless connection or a WLAN connection, each connection of the mobile telephones to the central server at least intermittently being a UMTS connection.

An exemplary embodiment is elucidated with the aid of the figures, and additional advantageous further developments of the present invention and its advantages are described.

### BRIEF DESCRIPTION OF THE DRAWINGS

FIG. 1 shows a schematic representation of a system according to the present invention.

FIG. 2 shows an illustration of a mobile telephone having an exemplary display on its display.

### DETAILED DESCRIPTION

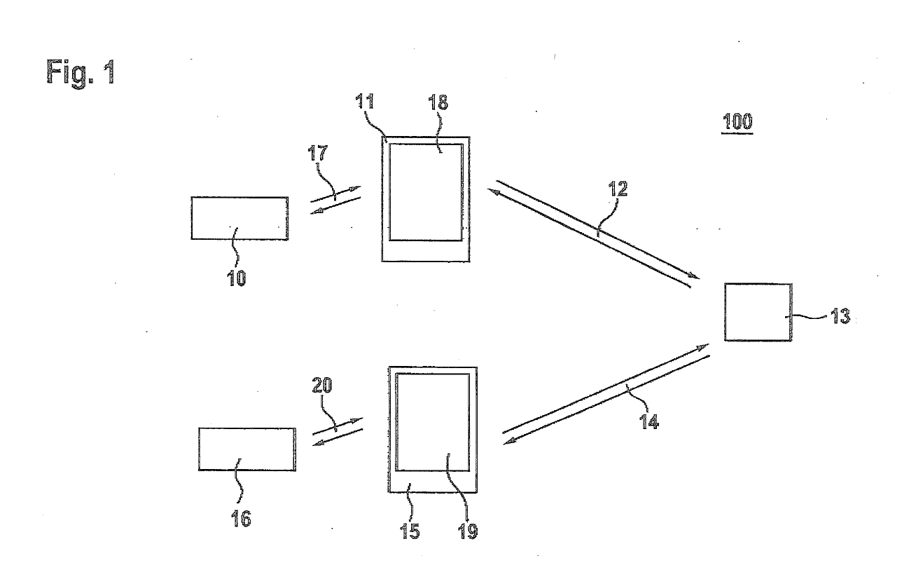

FIG. 1 shows a system 100, in which two motor vehicles 10 and 16 are part of system 100 by way of example. The number of vehicles or users may also be higher. Each vehicle 10, 16 is assigned a mobile telephone 11, 15, which is implemented as so-called smartphone.

Vehicle 10 includes an interface for transmitting user data or vehicle data via a communication connection 17. Communication connection 17 is a WLAN connection. Other wireless connections such as Bluetooth are possible as well. In addition or as an alternative, a vehicle position may be determined via communication connection 17 as well, which is ascertained either by a navigation device integrated in vehicle 10, or by a mobile navigation device, which, for example, is mountable on the inside of a front windshield of the vehicle using the known suction cup mounting mechanism. If the mobile phone has a GPS receiver, it is also possible to use that device to determine the position.

First mobile phone 11 is connected to a web server 13 via a first Internet connection 12. Connection 12 is a UMTS connection. The data of Internet connection 12 are transmitted to central server 13 in encrypted form. Its positional information may be transmitted to server 13 and forwarded to a second mobile telephone 15, which is assigned to a second motor vehicle 16. In analogous manner, second motor vehicle 16 is provided with a second internal communication connection 20, which connects second mobile telephone 15 to the motor vehicle for a data exchange, as illustrated in FIG. 1. Encrypted data from server 13 may then be transmitted to a further service provider.

FIG. 1 illustrates a system 100 in which both mobile telephones 11, 15 are wirelessly networked via a common central server 13. Each mobile telephone 11, 15 is connected to the corresponding vehicle using a communication line 17, 20. Vehicle data are provided in such a way that a user receives vehicle data and/or vehicle positions of the other users and displays them on a display 18, 19 of mobile telephone 11, 15.

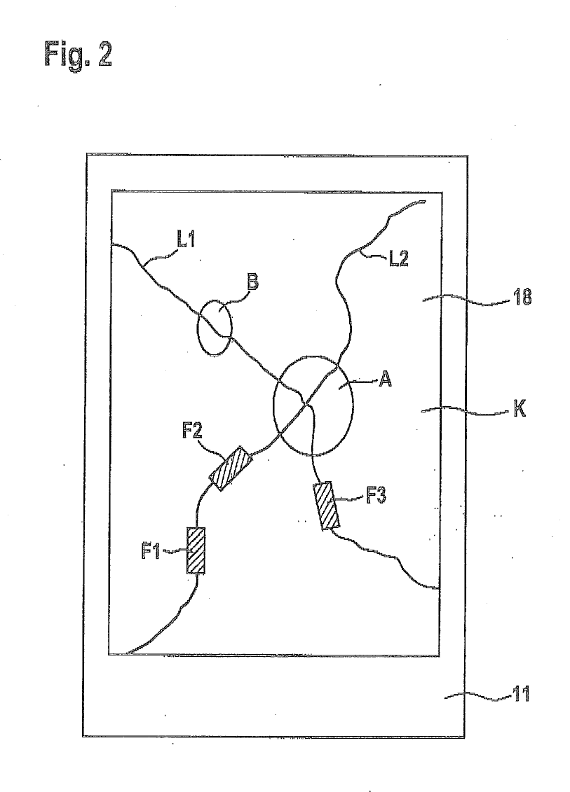

FIG. 2 shows a so-called APP for the shared networking of mobile telephones 11 and 15. By way of example, three users or vehicles F1, F2, F3 are shown on a general map K, and a road map with two roads, e.g., two highways L1, L2. Super highways and other roads may be displayed as well. In addition, two cities A, B or other towns, POIs (points of interest) are shown on display 18 of mobile telephone 11. As illustrated in FIG. 2, the vehicle positions of vehicles F1, F2, F3 are shown on a general map of corresponding mobile telephone 18. Information, such as the tank fill status or some other vehicle state, e.g., oil pressure, cooling water temperature and the like, are able to be displayed in this display or also in some other display view (without map). The necessary measured values are provided by sensors in the known manner.

Using these methods together with system 100, a travel group consisting of multiple vehicles F1, F2, F3 is able to be interconnected. Information of fellow travelers, which is not necessarily restricted to vehicle information, is able to be exchanged via the mobile telephones assigned to the vehicles. Especially information about a vehicle position, vehicle speed, a tank fill level and/or a vehicle status is exchanged. Other exchangeable information could be a pulse rate of a person. This would require a corresponding data transmission between a pulse rate measuring device and the mobile telephone. Therefore, other data that are related to the vehicle (e.g., pulse rate of the driver of vehicle F1) are likewise vehicle data within the meaning of this description.

Very relevant, however, is the transmission of the vehicle positions. For data received from mobile telephone 11 may also be used to improve and/or update navigation map material and/or to generate congestion forecasts.

The present invention is not limited to this exemplary embodiment. For instance, it is possible to use so-called tablets or PCs instead of smartphones. The term “telephone” need not necessarily encompass the classic telephone functionality. Internet telephony is also an option, so that a PC is a corresponding system.

What is claimed is:

1. A system, comprising:
a shared central server; and
mobile telephones networked in wireless manner via the shared central server;
wherein each of the mobile telephones is connected to a communication line of a vehicle, which provides vehicle data, such that a user receives at least one of vehicle data and vehicle positions of the other users and displays them on a display of the mobile telephone.

2. The system of claim 1, wherein the central server is a web server.

3. The system of claim 1, wherein the data are at least one of transmitted in encrypted form to a central server and transmitted from the central server to a further service provider.

4. The system of claim 1, wherein each of the mobile telephones is equipped with a GPS receiver.

5. The system of claim 1, wherein at least one of the vehicle data and the vehicle positions are displayable on a general map of the individual mobile telephone.

6. The system of claim 1, wherein each of the mobile telephones is implemented as smartphone having a common networking application.

7. The system of claim 1, wherein each communication from one of the mobile telephones to the vehicle takes place by a WLAN connection.

8. The system of claim 1, wherein each connection of the mobile telephones to the central server is a UMTS connection.

9. A method, comprising:
using a system to interconnect a travel group made up of multiple vehicles to obtain, via the mobile telephones, information from fellow travelers, especially regarding at least one of a vehicle position, a vehicle speed, a tank fill level and a vehicle status;
wherein the system includes:
a shared central server; and
mobile telephones networked in wireless manner via the shared central server, wherein each of the mobile telephones is connected to a communication line of a vehicle, which provides vehicle data, such that a user receives at least one of vehicle data and vehicle positions of the other users and displays them on a display of the mobile telephone.

10. The method of claim 9, wherein received data are used to at least one of improve navigation map material, update navigation map material, and to generate congestion forecasts.
